(19) United States
(12) Patent Application Publication
(10) Pub. No.: US 2014/0321664 A1
(43) Pub. Date: Oct. 30, 2014

(54) METHODS FOR DYNAMICALLY PROGRAMMING A MICROPHONE

(71) Applicant: FORTEMEDIA, INC., Sunnyvale, CA (US)

(72) Inventors: Yen-Son Paul HUANG, Los Altos Hills, CA (US); Sho-Mo CHEN, San Jose, CA (US); Iou-Din Jean CHEN, San Jose, CA (US)

(73) Assignee: Fortemedia, Inc., Sunnyvale, CA (US)

(21) Appl. No.: 13/870,364

(22) Filed: Apr. 25, 2013

(51) Int. Cl. H04R 29/00

(52) U.S. Cl. CPC H04R 29/005
USPC 381/92

(57) ABSTRACT

Methods for dynamically programming a microphone are provided. The method, adopted by a microphone system including a first microphone device and a host device connected thereto, includes: transmitting, by the host device, a command message to the first microphone device; receiving, by the first microphone device, a command message from the host device; decoding, by the first microphone device, the command message; dynamically performing, by the first microphone device, an operation based on the decoded command message to generate first data; and receiving, by the host device, first data from the first microphone device.

### BACKGROUND OF THE INVENTION

1. Field of the Invention

The present invention relates to microphone systems, and in particular, to methods for dynamically programming a microphone.

2. Description of the Related Art

A microphone array comprises multiple microphones converting the sounds that are received to multiple electrical signals. Because the electrical signals generated by a microphone array have phase difference and gain difference therebetween due to diversity of location and device property, it is preferred to configure and program the microphone array based on the environment, enhancing the sound performance and increasing the user experience.

### BRIEF SUMMARY OF THE INVENTION

A detailed description is given in the following embodiments with reference to the accompanying drawings.

An embodiment of a method is provided, adopted by a microphone system including a first microphone device and a host device connected thereto, comprising: transmitting, by the host device, a command message to the first microphone device; receiving, by the first microphone device, a command message from the host device; decoding, by the first microphone device, the command message; dynamically performing, by the first microphone device, an operation based on the decoded command message to generate first data; and receiving, by the host device, first data from the first microphone device.

Another embodiment of a method is disclosed, adopted by a first microphone device connected to a host device, comprising: receiving a command message from the host device; decoding the command message; and dynamically performing an operation based on the decoded command message.

Another embodiment of a method is described, adopted by a host device connected to a first microphone device, comprising: transmitting a command message to the first microphone device; and in response to the transmitted command message, receiving first data dynamically from the first microphone device, which is dynamically adjusted according to the command message.

### BRIEF DESCRIPTION OF THE DRAWINGS

The present invention can be more fully understood by reading the subsequent detailed description and examples with references made to the accompanying drawings, wherein:

FIG. 1 is a block diagram of a microphone system 1 according to an embodiment of the invention.

FIG. 2 is a block diagram of a microphone system 2 according to another embodiment of the invention.

FIG. 3 is a block diagram of a microphone system 3 according to still another embodiment of the invention.

FIG. 4 is a flowchart of the CS programming method 4 adopted by a microphone according to an embodiment of the invention.

FIG. 5 is a flowchart of the CS programming method 5 adopted by a host device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It should be noted that the microphone system herein may reside in a voice recorder, a mobile phone, a computer, a tablet, or any computing, communication, or consumer electronic device.

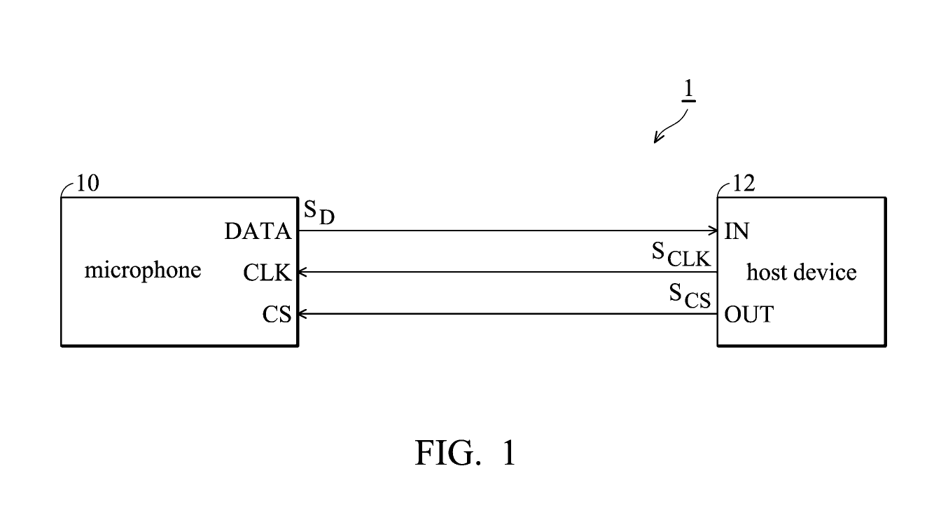

FIG. 1 is a block diagram of a microphone system 1 according to an embodiment of the invention, including a microphone 10 (first microphone device) and a host device 12. The microphone system 1 utilizes a communication protocol, referred to as a CS protocol hereinafter, between the microphone 10 and the host device 12, so that the host device 12 can actively and dynamically configure the settings of the microphone 10, send a test pattern to the microphone 10, or acquire certain information from the microphone 10 when the microphone system 1 is in operation.

The microphone 10 is connected to the host device 12 through a DATA pin, a CLK pin and a chip select (CS) pin. Although not shown in FIG. 1, the microphone 10 also includes power (VDD) and ground (VSS/GND) pins which are connected to a power source for acquiring power for operation. Through the CLK pin, the microphone 10 receives a clock signal S_{CLK} from the host device 12, and through the DATA pin, the microphone 10 outputs a digital data signal S_{D} to the host device 12. The CS pin is an input pin on the microphone 10, which is conventionally tied to either a logic HIGH or logic LOW for outputting the digital voice data S_{D} on the DATA pin upon being triggered by a positive edge or a negative edge of the clock signal S_{CLK}.

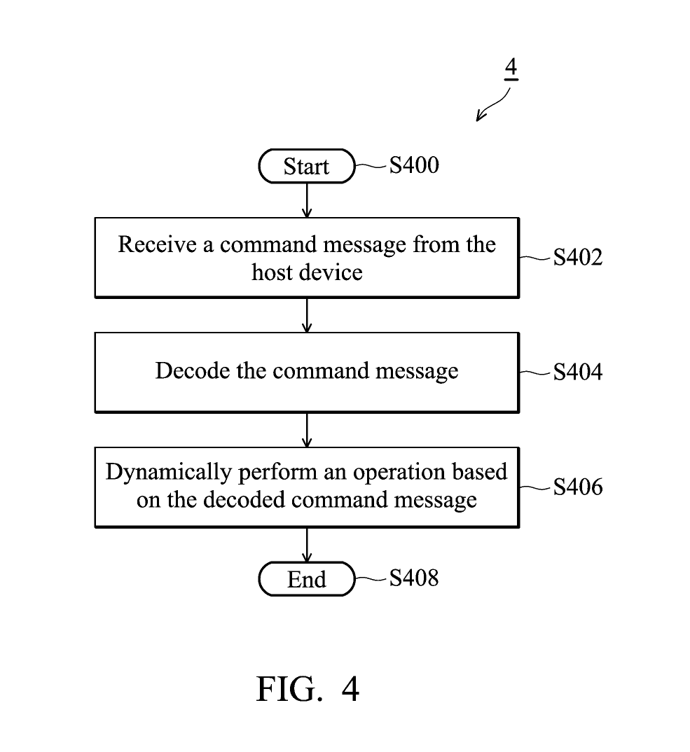

In the embodiment, the CS protocol is implemented on a CS connection line between the CS pin of the microphone 10 and an OUT pin of the host device 12. The OUT pin may be a GPIO or a PDM output on the host device 12. After an end-user turns on the microphone system 1, the host device 12 can actively send a command message by a CS signal S_{CS} through the OUT pin to configure the settings of the microphone 10, query information from the microphone 10, or input a scan test pattern to the microphone 10. The configuration that may be set by the command message includes the CS pin configuration, gain, phase, sensitivity, frequency response, power setting, a charge pump bias voltage level, or other adjustable parameters in the microphone 10. The host device 12 can query the information of the microphone 10, such as current state, current configuration, or a value held in a register of the microphone 10. Further, in a test mode, the host device 12 can feed a scan test pattern into the microphone 10, verifying the functioning and validity of circuits, components, or blocks in the microphone 10. Details for various command messages sent by the host device 12 and corresponding operation carried out in microphone 10 are provided in a CS programming method 4 in FIG. 4.

The microphone 10 may be a digital capacitor microphone or a digital MicroElectrical-mechanical System (MEMS) microphone, and both contain an acoustic transducer converting air pressure into an analog electrical signal and an analog-to-digital converter converting the analog electrical signal into digital, offering the advantage of increased immunity of electrical noise pickup. The host device 12 may be one or more central processing units, digital signaling processors, microcontrollers, codecs, controllers, or a combination thereof.

In some embodiments, the host device 12 may contain a memory (not shown) and a processor (not shown). The processor is configured to load a CS protocol program from the memory for execution. The CS protocol program provides an intelligent CS protocol control for automatically generating an appropriate command message without the needs for user intervention.

The microphone system 1 provides back compatibility for the conventional CS pin connection. In some embodiments, the CS pin of the microphone 10 may be left floating or may not be connected. Upon detecting the CS pin floating or not being connected, the microphone 10 may internally connect the CS pin to a logic HIGH state or a logic LOW state by a default configuration. In other embodiments, the CS connection line is disconnected between the microphone 10 and the host device 12, and the CS pin may be connected to a VDD (logic HIGH state) or VSS (logic LOW state) voltage level. The microphone 10 may output the digital data signal S_{D} on the DATA pin upon a rising edge or a falling edge of the clock signal S_{CLK} according to the fixed CS pin connection.

The microphone system 1 utilizes the CS protocol between the microphone 10 and the host device 12, allowing the host device 12 to query for information and configure the internal settings of the microphone 10 on the fly, thereby providing a certain degree of programmability for the microphone.

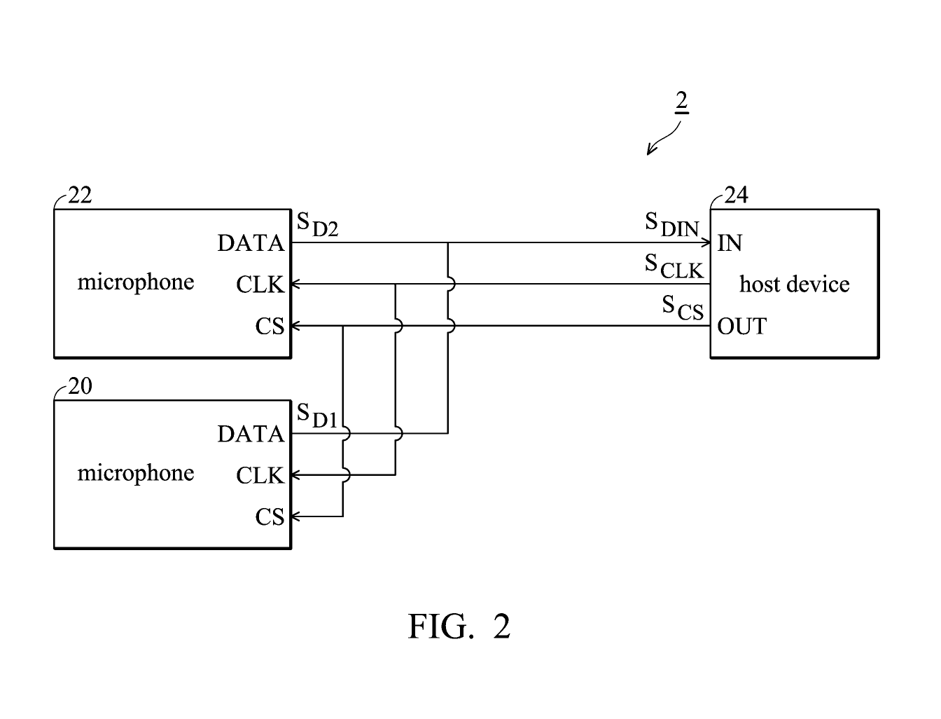

FIG. 2 is a block diagram of a microphone system 2 according to another embodiment of the invention, including microphones 20 (first microphone device) and 22 (second microphone device) connected in parallel to a host device 24, that is, the microphones 20 and 22 receive the same command message from the host device 24 and transmit respective digital audio data on signals S_{D1} and S_{D2} to a common input pin IN on the host device 24. As a consequence, the command message is configured to include information on which microphone the command message is intended for, along with the operation for the intended microphone to carry out. Further, the microphones 20 and 22 are configured to transmit by different channels or at different times. For example, when the microphone 20 is assigned to a first channel by setting the CS pin state of the microphone 20 to the logic HIGH, the other microphone should be assigned to a second channel by setting the CS pin state of the microphone 22 to the logic LOW, so that only one of the microphones is allowed to transmit data to the host device 12 at any given time.

In some embodiments, the host device 24 may transmit corresponding command messages to the microphones 20 and 22 by two separate GPIOs or other type of output pins (not shown). In the case of two dedicated CS connection lines being used, the command message is not required to include the intended microphone information. The two microphones 20 and 22 may be programmed by the host device 24 separately through the dedicated CS connection lines.

The microphone system 2 is distinct from the microphone system 1 in that it is an array microphone, requiring matched microphone performance for the two microphones 20 and 22 to produce increased performance in beam forming When the two microphones 20 and 22 are placed close together or packed into a package with limited space, with the distance therebetween being less than 1 cm, it is difficult to provide matching for the two microphones 20 and 22 in the conventional approach.

In the embodiment, the microphone system 2 employs the CS protocol to resolve the matching issue. When the microphone system 2 is used in vast ranges of voice communication environments including close talk, hands free, and far field, the microphone system 2 can modify the parameters of the microphones dynamically or statically, providing the most suitable configuration of the microphones 20 and 22 for the specific voice communication environment.

The OUT pin of the host device 24 is connected to the CS pins of the microphones 20 and 22, so that the host device 24 can actively and dynamically issue command messages on the CS signal S_{CS} to adjust the sensitivities, the phases, and the frequency responses (gains) of the microphones 20 and 22, providing matching for the microphones in the array microphone system 2 on the fly, leading to enhanced voice quality (VQ) and voice recognition rate (VR) in the microphone system 2.

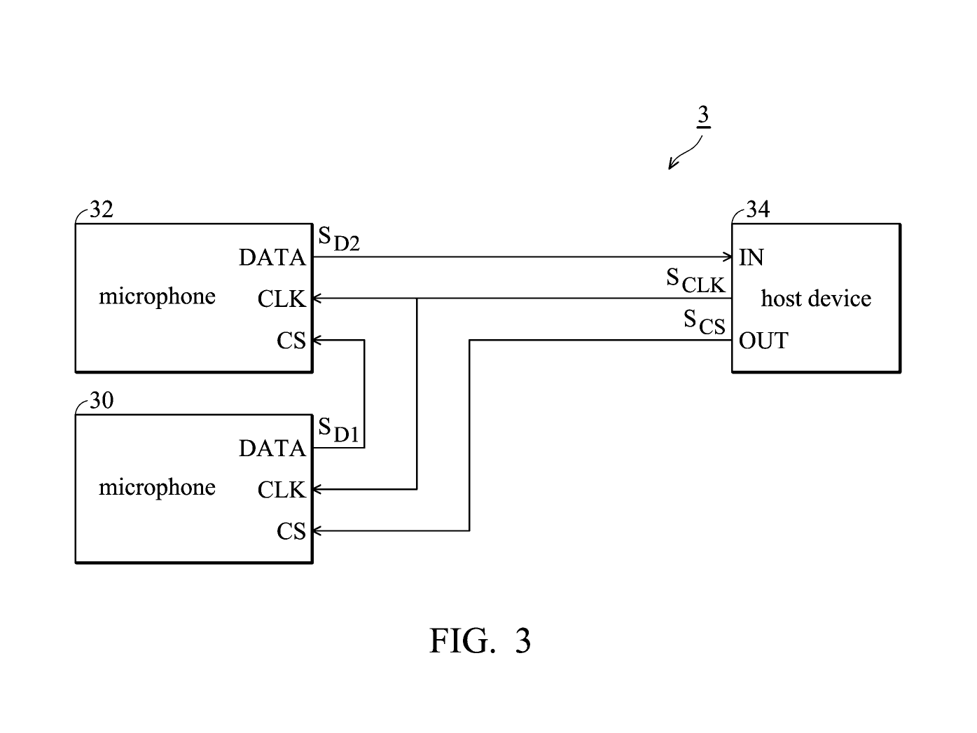

FIG. 3 is a block diagram of a microphone system 3 according to still another embodiment of the invention, including a host device 34 coupled to a microphone 30 (first microphone device), which is subsequently coupled to a microphone 32 (second microphone device) in series, and which is further coupled to a host device 34.

The microphone system 3 is distinct from the microphone system 1 in that the microphones 30 and 32 are connected in series rather than in parallel. The DATA pin of the first microphone 30 (reference microphone), is connected to the CS pin of the second microphone 32 (main microphone). Only the first microphone 30 is configured to receive the command signal on the CS signal S_{CS} from the host device 34.

Since only the first microphone 30 can receive the command message, the host device 34 can only command the microphone 30 with the CS protocol to perform the various operations disclosed in FIG. 1 and FIG. 4.

After receiving the digital audio data on the signal S_{D1}, the second microphone 32 is configured to perform advanced echo cancellation (EC) and noise suppression (NS) functions to the received digital audio data and the local digital audio data of the second microphone 32, incorporate the EC and NS processed data into a resultant digital audio data, and output the resultant digital audio data by the signal S_{D2} to the host device 34.

The microphone system 3 utilizes the CS protocol between the microphone 30 and the host device 34, allowing the host device 34 to query for information and configure the internal settings of the microphone 30 in a dynamic and active way, thereby providing a certain degree of programmability for the microphone 30.

FIG. 4 is a flowchart of the CS programming method 4 according to an embodiment of the invention, incorporating the microphones in FIGS. 1 through 3. For explanatory purposes, the following will mainly uses the microphone system 1 to explain the details of the CS programming method 4.

Upon startup, the microphone system 1 is powered on, the host device 12 is configured to send a command message to configure channel selection for the microphone 10. The microphone 10 is configured to latch the command message on the CS signal S_{CS} by the clock signal S_{CLK}, decode the command message, and assign or connect the CS pin state to the logic HIGH state or the logic LOW state according to the decoded command message. After the channel selection procedure has been completed, the microphone 10 is ready to transmit the digital audio signal S_{D} to the host device 12 according to the selected channel (S400). In certain embodiments, the initial channel selection procedure would take 50˜100 ms after power-on.

The host device 12 is free to send further command messages by the CS signal S_{CS}. Correspondingly, the microphone 10 would receive and obtain the command messages on the CS signal S_{CS} by the clock signal S_{CLK} (S402). In a normal operation mode the command message represents a configuration or an information query to the microphone 10. In a test mode, the command message represents a testing pattern for conducting a test for the microphone 10. The mode of the operation may be selected by hardware or software implementation. For example, the microphone 10 may further include a test-enable pin (not shown). When the test-enable pin is connected to VDD, the test mode is selected, and when the test-enable pin is connected to VSS, the normal operation mode is selected. In another example, the host device 12 is configured to load a software program for a mode-control interface. When a user selects the test mode, the host device 12 issues a command message indicating that the test mode is being selected. Similarly, when the user selects the normal operation mode, the host device 12 correspondingly issues a command message indicating that the normal operation mode is being selected. The command message may be a configuration to a setting of the microphone, such as CS pin configuration (channel selection), gain, phase, sensitivity, frequency response, power setting, a charge pump bias voltage level, echo cancellation, noise suppression, or another parameter or function configuration in the microphone 10. The command message may also contain a query for certain information in the microphone 10, such as the current state, the current configuration, or the value held in a register in the microphone 10. The command message may be a testing pattern in the test mode.

After receiving the command message from the CS pin, the microphone 10 is configured to decode the command message to determine which command it is (S404), and dynamically perform the operation that the decoded command message indicates (S406).

In some embodiments, when the decoded command message indicates a selected channel, the microphone 10 is configured to assign or connect the CS pin according to the selected channel. For example, the microphone 10 may configure the CS pin state to the logic HIGH according to the selected channel, and transmit the digital audio data on the rising edge of the clock signal S_{CLK} to the host device 12. The microphone 10 may also configure the CS pin state to the logic LOW according to the selected channel, and transmit the digital audio data on the falling edge of the clock signal S_{CLK} to the host device 12.

In other embodiments, when the decoded command message indicates a change in the gain or the frequency response of the microphone, the microphone 10 is configured to modify the gain or the frequency response of a transmitter in the microphone 10 accordingly.

In some other embodiments, when the decoded command message indicates a change in the phase of the microphone, the microphone 10 is configured to modify the phase of a transmitter in the microphone 10 correspondingly.

In yet other embodiments, when the decoded command message indicates a change in the power setting, such as a “power down” or a “wake up” command, the microphone 10 is configured to modify the power state according to the power setting.

In still other embodiments, when the decoded command message indicates a change in an internal parameter, such as the charge pump bias voltage level, the microphone 10 is configured to modify the value of the internal parameter accordingly.

In other embodiments, when the decoded command message indicates a configuration for a built-in function, such as activation or deactivation of the echo cancellation, or activation or deactivation of the noise suppression, the microphone 10 is configured to modify the configuration of the built-in function accordingly.

In other embodiments, when the decoded command message indicates a query for information about the microphone 10, such as an operation mode or a state of the microphone, or an internal parameter of the microphone, the microphone is configured to transmit the requested information on the data signal S_{D} by the DATA pin at the next clock cycle to the host device 12.

In other embodiments, when the decoded command message indicates a test mode and includes a testing pattern, the microphone 10 is configured to carry out the device test for devices, circuits and blocks in the microphone 10 using the testing pattern. In some embodiments, the microphone 10 can return the testing output data to the host device 12 via the data signal S_{D} output by the DATA pin. In other embodiments, the microphone 10 can evaluate the testing output data to determine the functionality and validity of each tested device, circuit or block, and send the evaluation results to the host device 12 by the data signal S_{D}.

In Step S408, the microphone has completed the requested operation and the CS programming method 4 is completed and exited.

The CS programming method 4 utilizes the CS protocol between the microphone and the host device, allowing the microphone device to receive information queries, internal parameter configurations, or perform a scan test in a dynamic and active way, thereby providing a certain degree of programmability for the microphone.

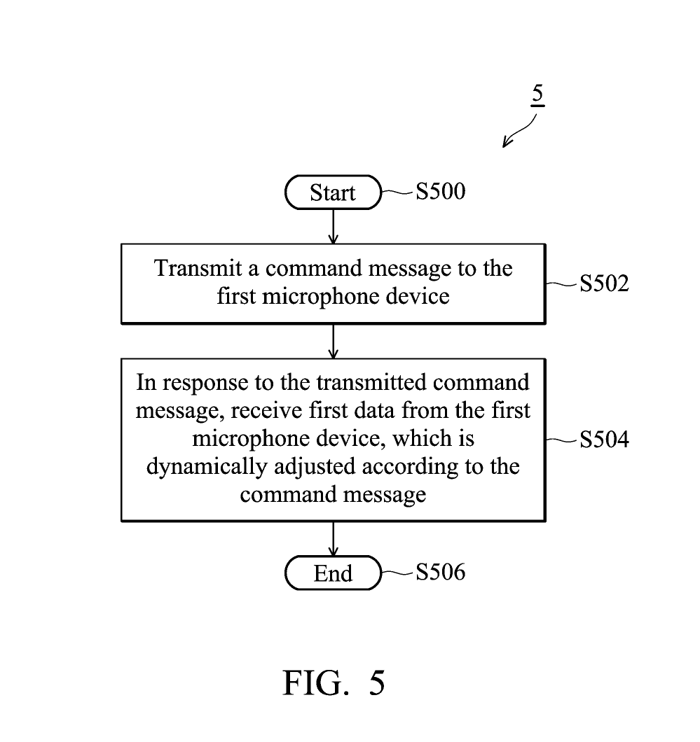

FIG. 5 is a flowchart of the CS programming method 5 according to another embodiment of the invention, incorporating the host device in FIGS. 1 through 3. For explanatory purposes, the following will mainly uses the microphone system 1 to illustrate the details of the CS programming method 5.

Upon startup, the microphone system 1 is powered on, the host device 12 is configured to send a command message to configure channel selection for the microphone 10. The microphone 10 is configured to latch the command message on the CS signal S_{CS} by the clock signal S_{CLK}, decode the command message, and assign or connect the CS pin state to the logic HIGH state or the logic LOW state according to the decoded command message. After the channel selection procedure has been completed, the microphone 10 is ready to transmit the digital audio signal S_{D} to the host device 12 according to the selected channel (S500).

The host device 12 is then configured to program the microphone 10 by transmitting a command message on the CS signal S_{CS} (S502), which may contain a configuration request, an information query, or a test request as detailed by Steps S402 and S404 in FIG. 4.

In response to the transmitted command message, the host device 12 is configured to receive first data from the microphone 10. The received first data is dynamically adjusted according to the command message (S504). Referring to Step S404 in FIG. 4, upon receiving the command message, the microphone 10 is configured to perform an operation according to the command message and subsequently transmit the first data via the DATA pin to the host device 12.

In some embodiments, the decoded command message indicates a selected channel, and the host device 12 is configured to receive the first data on the data signal S_{D} according to the selected channel and the clock signal S_{CLK}. For example, when the command message assigns the microphone 10 to configure the CS pin state to the logic HIGH, the host device 12 is configured to receive the digital audio data on the rising edge of the clock signal S_{CLK} from the microphone 10. When the command message assigns the microphone 10 to configure the CS pin state to the logic LOW, the host device 12 is configured to receive the digital audio data on the falling edge of the clock signal S_{CLK} from the microphone 10.

In other embodiments, when the command message indicates a change in the gain or the frequency response of the microphone, the host device 12 is configured to receive the first data with the gain or the frequency response adjusted by the change indicated in the command message.

In some other embodiments, when the command message indicates a change in the phase of the microphone, the host device 12 is configured to receive the first data with the phase adjusted by the change indicated in the command message.

In yet other embodiments, when the command message indicates a change in the power setting, such as a “power down” or a “wake up” command, the host device 12 may expect the occurrence of the first data at the IN pin according to the power setting.

In still other embodiments, when the command message indicates a change in an internal parameter, such as the charge pump bias voltage level, the host device 12 is configured to receive the first data with the internal parameter being modified accordingly.

In other embodiments, when the command message indicates a configuration for a built-in function, such as activation or deactivation of the echo cancellation, or activation or deactivation of the noise suppression, the host device 12 is configured to receive the first data with the configuration of the built-in function modified at the microphone 10 accordingly.

In other embodiments, when the command message indicates a query for information about the microphone 10, such as an operation mode or the state of the microphone, or an internal parameter of the microphone, the host device 12 is configured to receive the requested information on the data signal S_{D} as the first data from the microphone 10.

In other embodiments, when the command message indicates a test mode and includes a testing pattern, the host device 12 is configured to receive the testing output data from the microphone 10. In yet other embodiments, the host device 12 is configured to receive the evaluation results of the test from the microphone 10.

In Step S506, the host device 12 has completed programming the microphone 10 and the CS programming method 5 is completed and exited.

The CS programming method 5 utilizes the CS protocol between the microphone and the host device, allowing the host device to query for information, configure internal settings, or perform a scan test for the microphone 30 in a dynamic and active way, thereby providing a certain degree of programmability for the microphone.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general-purpose processor, a digital signal processor (DSP), an application-specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, units, modules, circuits and systems described herein may be implemented by way of, but not limited to, hardware, firmware, software, software in execution, and combinations thereof.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method adopted by a microphone system including a first microphone device and a host device connected thereto, comprising:
transmitting, by the host device, a command message to the first microphone device;
receiving, by the first microphone device, a command message from the host device;
decoding, by the first microphone device, the command message;
dynamically performing, by the first microphone device, an operation based on the decoded command message to generate first data; and
receiving, by the host device, first data from the first microphone device.

2. The method of claim 1, wherein:
the step of receiving the command message comprises receiving the command message by a chip select (CS) pin of the first microphone device.

3. A method adopted by a first microphone device connected to a host device, comprising:
receiving a command message from the host device;
decoding the command message; and
dynamically performing an operation based on the decoded command message.

4. The method of claim 3, wherein:
the step of receiving the command message comprises receiving the command message by a chip select (CS) pin of the first microphone device.

5. The method of claim 3, further comprising:
receiving a clock signal from the host device;
wherein the decoded command message indicates a selected channel; and
the step of dynamically performing comprises outputting first microphone data to the host device according to the selected channel and the clock signal.

6. The method of claim 3, wherein:
the step of dynamically performing comprises adjusting a gain of a transmitter in the first microphone device according to the decoded command message.

7. The method of claim 3, wherein:
the step of dynamically performing comprises adjusting a phase of a transmitter in the first microphone device according to the decoded command message.

8. The method of claim 3, wherein:
the step of dynamically performing comprises adjusting a sensitivity of a receiver in the first microphone device according to the decoded command message.

9. The method of claim 3, wherein:
the step of dynamically performing comprises configuring a power setting for the first microphone device according to the decoded command message.

10. The method of claim 3, wherein:
the step of dynamically performing comprises transmitting a requested information of the first microphone device to the host device according to the decoded command message.

11. The method of claim 3, wherein:
the command message comprises a test pattern;
the step of dynamically performing comprising performing a test for a circuit in the first microphone device according to the test pattern; and
transmitting a test result of the performed test to the host device.

12. The method of claim 3, further comprising:
transmitting data to a second microphone device.

13. A method adopted by a host device connected to a first microphone device, comprising:
transmitting a command message to the first microphone device; and
in response to the transmitted command message, receiving first data from the first microphone device, which is dynamically adjusted according to the command message.

14. The method of claim 13, wherein:
the step of transmitting the command message comprises transmitting the command message to a chip select (CS) pin of the first microphone device.

15. The method of claim 13, further comprising:
transmitting a clock signal to the first microphone device;
wherein the command message indicates a selected channel; and
the step of receiving the first data comprises receiving the first data according to the selected channel and the clock signal.

16. The method of claim 13, wherein:
the step of receiving the first data comprises receiving the first data with a gain adjusted by the command message.

17. The method of claim 13, wherein:
the step of receiving the first data comprises receiving the first data with a phase adjusted by the command message.

18. The method of claim 13, wherein:
the step of receiving the first data comprises receiving a requested information of the first microphone device according to the decoded command message.

19. The method of claim 13, wherein:
the command message comprises a test pattern; and
the step of receiving the first data comprises receiving a test result of a test performed on the first microphone device according to the test pattern.

20. The method of claim 13, further comprising:
transmitting the command message to a second microphone device; and
in response to the transmitted command message, receiving second data dynamically adjusted according to the command message from the second microphone device.
